(19) United States
(12) Patent Application Publication
(10) Pub. No.: US 2013/0008079 A1
(43) Pub. Date: Jan. 10, 2013

(54) Coagulation of oil in water and the resulting floating semisolid complex

(75) Inventors: Deborah Duen Ling Chung, East Amherst, NY (US); Yong Fu, Amherst, NY (US)

(73) Assignee: Dr. Deborah Duen Ling Chung, East Amherst, NY (US)

(21) Appl. No.: 13/176,618

(22) Filed: Jul. 5, 2011

(51) Int. Cl. C10L 1/32; C02F 1/54; B01D 17/04; C09K 3/32; C02F 1/52; C02F 1/56; B82Y 99/00; C02F 101/32

(52) U.S. Cl. 44/280; 210/708; 252/61; 977/742; 977/902

(57) ABSTRACT

This invention provides a semisolid complex exhibiting (i) the ability to float on water, (ii) the ability to provide liquid oil upon being deformed, and (iii) the ability to function as a fuel, the complex comprising a high proportion of liquid oil, the density of the oil being lower than the density of water, the complex also comprising fibers, the fibers being oriented in a plurality of directions, the fibers forming a framework, the framework being incorporated in the complex, the framework being substantially in the plane of the complex in case that the complex is in the form of a sheet, and the framework extending substantially over the area of the complex in case that the complex is in the form of a sheet, the complex further comprising a low proportion of bentonite, the bentonite being associated with the oil, the associating substantially involving coagulation, the oil and the bentonite being substantially held by the framework. This invention also provides a composition for causing the coagulation of a substantial portion of the oil present in a liquid upon the addition of the composition to the liquid, wherein the liquid comprises a high proportion of water and the liquid also comprises the oil, the density of the oil being lower than the density of the water, the composition comprising a mixture, the mixture comprising a high proportion of discontinuous fibers, the fibers being oriented in a plurality of directions, the mixture also comprising bentonite particles, the bentonite particles being sufficiently high in proportion for associating with a substantial portion of the oil, the associating substantially involving coagulation, and the fibers being sufficiently low in density and sufficiently high in proportion for causing the product of the coagulation to exhibit the ability to float on water. This invention further provides a method of coagulation of a substantial portion of the oil present in a liquid, wherein the liquid comprises a high proportion of water.

### FIELD OF THE INVENTION

This invention relates to the field of the removal of oil from water. It also relates to the field of oil spill clean-up. It further relates to the field of waste water treatment. It still further relates to the field of oil coagulation.

### BACKGROUND OF THE INVENTION

The removal of oil from water is practically important for oil spill clean-up and for the treatment or purification waste water that contains oil. Oil is found in numerous types of waste water, including tanker ballast water, oil field water, storm water from parking lots, vehicle wash water, process water from factories, landfill leachate, groundwater near storage tanks and boiler feed water. The types of oil include insoluble hydraulic fluids, crude oils, bunker oils and lubricant oils. Coagulation is one of the methods for the removal of oil from water.

Coagulation refers to the transformation of a liquid to a soft, semisolid, or solid mass. Coagulation requires the use of a small amount of a coagulant, which is a material that causes coagulation. The mechanism of coagulation involves flocculation, i.e., coalescence, such as the coalescence of oil droplets in case of oil coagulation. This means that coagulation does not merely involve absorption or adsorption.

Adsorption refers to the adhesion of a substance (e.g., a substance in the form of molecules) to a surface to form a film. The recovery of the substance adsorbed (i.e., removal of the substance from the surface so as to obtain the substance in a free form) involves desorption, which typically requires heating, which is a relatively expensive process.

Absorption refers to the incorporation of a substance in one state (such as a liquid state) into a material of a different state (such as a solid state) and typically involves the permeation of the substance into the material. The recovery of the absorbed substance involves desorption that typically requires heating, which is a relatively expensive process. In case that the material in which the substance is absorbed is sufficiently soft, the recovery may be performed by squeezing the material.

Oil coagulants are materials used to cause the coagulation of oil. Due to their low cost, natural coagulants, such as minerals, are attractive for large-scale environmental applications. An example of an oil coagulant is clay (such as bentonite) (US 2008/0142447). Bentonite is aluminum silicate clay formed from volcanic ash. Due to their high abundance and fine microstructure, clay minerals (particularly montmorillonite) are used as coagulants. Montmorillonite constitutes 90% of the composition of an industrial grade bentonite, which is commonly used as a coagulant.

There are two main classes of bentonite, based on the dominant exchangeable ion that is weakly bound in the double layer of montmorillonite. They are sodium bentonite and calcium bentonite. Sodium bentonite swells more in water than calcium bentonite and has excellent colloidal ° properties.

Organically modified bentonite (called organobentonite) is made by modifying bentonite with quaternary ammonium cations via a cation exchange process. Organobentonite is much more expensive than unmodified bentonite.

Other examples of oil coagulants are a hydroxide or an oxide of calcium (U.S. Pat. No. 4,202,766), alum (US 2005/0194323), a cationic organic compound (U.S. Pat. No. 6,319,409), cationic polymers and silicate ions (U.S. Pat. No. 5,015,391), a carboxymethylated yeast mixed with a water-soluble polyvalent metal salt of an inorganic acid (U.S. Pat. No. 4,178,265), gilsonite (U.S. Pat. No. 5,118,425), a polymer of high molecular weight having jelling properties (U.S. Pat. No. 3,977,969), an oliophilic-based composition that includes in significant amounts a polypropylene glycol ether, an alcohol, an ester and polyoxyalkyl glycol ether (U.S. Pat. No. 6,054,055), a thermal reaction product of an oil component and a copolymer component (U.S. Pat. No. 5,961,823, U.S. Pat. No. 5,837,146), a glyceride in conjunction with a polymer (U.S. Pat. No. 5,746,925, U.S. Pat. No. 5,698,139, U.S. Pat. No. 5,437,793) and aqueous solutions of cellulose sulfate salts (U.S. Pat. No. 2,625,517),

A semisolid is a material that is partly solid and partly liquid. The solid or semisolid product of oil coagulation typically sinks in water due to the high density (greater than 1 g/cm³, which is the density of water) of the coagulation product. Due to the sinking tendency, waste water treatment involving coagulation commonly involves sedimentation as a part of the process (U.S. Pat. No. 6,447,686, U.S. Pat. No. 5,897,810). The sinking tends to cause inconvenience to the subsequent separation of the coagulation product from the water involved, particularly if the water is in a large amount, such as the amount in an ocean. The buoyancy of the coagulation product facilitates the removal of the coagulation product by scooping or other mechanical methods. In the case of water in an ocean, the sinking of the coagulation product also affects negatively the ecology of the ocean floor, thus causing environmental issues.

The floating of the oil coagulation product has been achieved by various methods, namely the use of pulverized hydrocarbon gilsonite (U.S. Pat. No. 5,118,425), the use of paraffinic hydrocarbons of low specific gravities (U.S. Pat. No. 3,940,334), the use of a polymer of high molecular weight having jelling properties (U.S. Pat. No. 3,977,969), the use of an oliophilic-based composition including significant amounts of a polypropylene glycol ether, an alcohol, an ester and polyoxyalkyl glycol ether (U.S. Pat. No. 6,054,055), the use of a thermal reaction product of an oil component (e.g., glycerides) and a copolymer (U.S. Pat. No. 5,961,823, U.S. Pat. No. 5,837,146, U.S. Pat. No. 5,746,925, U.S. Pat. No. 5,698,139 and U.S. Pat. No. 5,437,793), and the use of the process of electrolysis (U.S. Pat. No. 4,439,290). All these methods involve expensive materials (e.g., gilsonite, specific types of hydrocarbon and specific types of polymer), environmentally unfriendly materials that may cause pollution (e.g., ester and ether), and/or expensive processes (e.g., electrolysis and thermal reaction). Low cost and environmental friendliness are necessary for large-scale applications, such as oil spill clean-up.

In case of an oil-containing slurry that contains a soap component, the oil adheres to the froth that is produced by foaming, thereby the oil floats (U.S. Pat. No. 4,555,345). This method is limited to the case where a soap component is present and it does not involve coagulation.

The product of oil coagulation is in the form of small pieces of materials known as aggregates and of typical size less than 3 mm. Each aggregate comprises oil and a coagulant. The small size of the aggregates adds to the complexity of removing the aggregates from the pool of water in which the aggregates are formed.

Absorbents and adsorbents function without involving the process of coagulation. They are affected by fouling (which, for example, is associated with the clogging of the pores, i.e., the blocking of the pore opening), but coagulants are not affected by fouling. This is because coagulation takes place outside the coagulant particles, whereas absorption/adsorption takes place inside the pores of the absorbent/adsorbent. In addition, absorption and adsorption tend to suffer from the relatively small amount of material that can be absorbed or adsorbed, due to the insufficiently high values of the specific surface area (i.e., surface area per unit volume) and total pore volume (i.e., volume of all the pores together). Furthermore, due to the requirement of high specific surface area and high total pore volume, effective absorption or adsorption requires chemical or physical processing that is designed to provide the high specific surface area and/or high total pore volume. This processing adds to the cost of the absorbent or adsorbent. In contrast, because coagulation takes place outside the coagulant particles; the amount of material that can be coagulated is large and high values of the specific surface area and total pore volume are not required. Also because coagulation takes place outside the coagulant particles, recovery of the coagulated material (e.g., the recovery of oil in case of oil coagulation) tends to be easier than the recovery of adsorbed or absorbed materials.

Examples of oil absorbents are sawdust (US 2007/0082815), sulfite reject from a paper mill process (U.S. Pat. No. 4,551,253), corrugated cardboard (U.S. Pat. No. 5,549,178), a cellulosic-based fiber granule (U.S. Pat. No. 5,763,083), a material formed from treated paper sludge (U.S. Pat. No. 4,734,393), unglazed newsprint (U.S. Pat. No. 5,248,391), polymer fibers (U.S. Pat. No. 4,587,154), polymers (U.S. Pat. No. 5,374,600, U.S. Pat. No. 5,641,847, U.S. Pat. No. 5,688,843), crosslinked interpolymers of an alkylated styrene and a rubber (U.S. Pat. No. 5,239,007), a water-repellent polymeric carbohydrate composition (U.S. Pat. No. 4,780,518), and glass fibers (U.S. Pat. No. 4,006,079).

Examples of oil adsorbents are a mixture of silica and clay (U.S. Pat. No. 4,325,846), carbon (US 2007/0029246), calcined coke (U.S. Pat. No. 7,666,306), aluminosilicate exposed to a water-repellent treatment (U.S. Pat. No. 5,980,644), fibers treated with a water repellant (U.S. Pat. No. 5,252,215), calcium oxide (U.S. Pat. No. 7,754,642, US 2009/0137384), crushed raw oil shale (U.S. Pat. No. 4,308,146), resin (U.S. Pat. No. 3,862,963), polymers (US 2010/0230358, US 2010/0224566, U.S. Pat. No. 3,960,722, U.S. Pat. No. 5,976,221), a pitch-like substance (U.S. Pat. No. 4,209,382), natural fibers coated with a water-repellent paraffin layer and then an elastic rubber layer (U.S. Pat. No. 4,072,794),

The present invention is directed to overcoming these and other deficiencies in the art.

### SUMMARY OF THE INVENTION

This invention provides a semisolid complex exhibiting

(i) the ability to float on water,
(ii) the ability to provide liquid oil upon being deformed, and
(iii) the ability to function as a fuel,
said complex comprising a high proportion of liquid oil,
the density of said oil being lower than the density of water,
said complex also comprising fibers,
said fibers being oriented in a plurality of directions,
said fibers forming a framework,
said framework being incorporated in said complex,
said framework being substantially in the plane of said complex in case that said complex is in the form of a sheet, and
said framework extending substantially over the area of said complex in case that
said complex is in the form of a sheet,
said complex further comprising a low proportion of bentonite,
said bentonite being associated with said oil,
said associating substantially involving coagulation,
said oil and said bentonite being substantially held by said framework.

This invention also provides a composition for causing the coagulation of a substantial portion of the oil present in a liquid upon the addition of said composition to said liquid,

wherein said liquid comprises a high proportion of water and said liquid also comprises said oil,
the density of said oil being lower than the density of said water,
said composition comprising a mixture,
said mixture comprising a high proportion of discontinuous fibers,
said fibers being oriented in a plurality of directions,
said mixture also comprising bentonite particles,
said bentonite particles being sufficiently high in proportion for associating with a substantial portion of said oil,
said associating substantially involving coagulation, and
said fibers being sufficiently low in density and sufficiently high in proportion for causing the product of said coagulation to exhibit the ability to float on water.

This invention still further provides a method of coagulation of a substantial portion of the oil present in a liquid,

wherein said liquid comprises a high proportion of water and said liquid also comprises said oil,
the density of said oil being lower than the density of said water,
said method comprising the addition of a mixture to said liquid,
said mixture comprising a high proportion of discontinuous fibers,
said fibers being oriented in a plurality of directions,
said mixture also comprising bentonite particles,
said bentonite being sufficiently high in proportion for associating with a substantial portion of said oil,
said associating substantially involving coagulation, and
said fibers being sufficiently low in density and sufficiently high in proportion for causing the product of said coagulation to exhibit the ability to float on water.

Said oil is preferably chosen from the group consisting of hydrocarbon oils, polyols, organic liquids, mineral oils, hydraulic fluids, crude oils, bunker oils, lubricant oils, and combinations thereof.

Said bentonite is preferably chosen from the group consisting of sodium bentonite, calcium bentonite, magnesium bentonite, potassium bentonite, aluminum bentonite, organobentonite, montmorillonite, smectite clay, phyllosilicates, aluminum silicate clay, and combinations thereof.

Said bentonite is most preferably sodium bentonite.

Said fibers are preferably chosen from the group consisting of sawdust, stalk, paper, wood, cellulose, plant fibers, hairs, feathers, natural fibers, synthetic fibers, polymer fibers, carbon fibers, carbon nanofibers, carbon nanotubes, glass fibers, ceramic fibers, silicon carbide whiskers, tubular clays, halloysite nanotubes, and combinations thereof.

Said fibers are most preferably sawdust.

Said oil in said complex is preferably in an amount ranging from 65 vol. % to 95 vol. % of said complex.

Said fibers in said complex are at a proportion that is sufficient for said complex to float on water. Said fibers in said complex are preferably at a proportion ranging from 5 vol. % to 25 vol. % of said complex.

Said bentonite in said complex is preferably at a proportion ranging from 1 vol. % to 5 vol. % of said complex.

Said complex preferably further comprises calcium hydroxide.

Said mixture preferably further comprises calcium hydroxide.

Said fibers in said mixture are preferably at a proportion ranging from 70 vol. % to 95 vol. % of said mixture. Said bentonite in said mixture is preferably at a proportion ranging from 5 vol. % to 30 vol. % of said mixture.

Said fibers in said mixture are most preferably at a proportion ranging from 75 vol. % to 90 vol. % of said mixture. Said bentonite in said mixture is most preferably at a proportion ranging from 10 vol. % to 25 vol. % of said mixture.

### BRIEF DESCRIPTION OF THE DRAWINGS

FIG. 1 shows digital-camera optical photographs of the coagulation of oil in water, using organobentonite, sawdust and calcium hydroxide (formulation (i)) in small-scale testing. FIG. 1(a) shows the top view of a beaker and shows the coagulation product in a sheet form floating on the water in the beaker. FIG. 1(b) shows the side view of the beaker.

FIG. 2 shows a digital-camera optical photograph of the coagulation of oil in water, using bentonite, sawdust and calcium hydroxide (formulation (ii)) in medium-scale testing. It shows the top view of the container and shows the coagulation product in a sheet form floating on the water in the container. The spoon used in this paper is also shown.

FIG. 3 shows scanning electron microscope (SEM) photographs of the coagulation product (before drying) obtained by using organobentonite, sawdust and calcium hydroxide (formulation (i)).

FIG. 4 shows SEM photographs of the coagulation product (before drying) obtained by using bentonite, sawdust and calcium hydroxide (formulation (ii)).

FIG. 5 shows an SEM photograph of the coagulation product (before drying) obtained by using bentonite and sawdust (formulation (iii)).

FIG. 6 shows an SEM photograph of the coagulation product (before drying) obtained by using bentonite and calcium hydroxide (formulation (iv)).

FIG. 7(a) shows an SEM photograph of the coagulation product (after drying) obtained by using bentonite, sawdust and calcium hydroxide (formulation (ii)). FIG. 7(b) shows an X-ray spectrum obtained by X-ray spectroscopy at the point in FIG. 7(a) that is indicated by the black square and labeled “Spectrum 22”.

FIG. 8(a) shows an SEM photograph of the coagulation product (after drying in air) obtained by using bentonite, sawdust and calcium hydroxide (formulation (ii)). FIG. 8(b) shows an X-ray spectrum obtained by X-ray spectroscopy at the point in FIG. 8(a) that is indicated by the black square and labeled “Spectrum 20”.

FIG. 9(a) shows an SEM photograph of the coagulation product (after drying in air) obtained by using bentonite and calcium hydroxide (formulation (iv)). FIG. 9(b) shows an X-ray spectrum obtained by X-ray spectroscopy at the point in FIG. 9(a) that is indicated by the black square and labeled “Spectrum 3”.

FIG. 10 shows X-ray diffraction patterns. FIG. 10(a) shows the pattern for as-received bentonite. FIG. 10(b) shows the pattern for the coagulated material (formulation (ii)).

### DETAILED DESCRIPTION OF THE INVENTION

The coagulation of oil in water is valuable for the removal of oil from water. The coagulation results in a product comprising said oil. The subsequent removal of said product results in the removal of said oil.

This invention is directed at advancing the technology of oil coagulation in water by the synergistic use of fibers and a low proportion of bentonite. The use of fibers facilitates oil coagulation, thereby substantially enhancing the coagulation efficiency.

The use of fibers enables the product of said coagulation to have the ability to float on water. The use of fibers also enables the product of said coagulation product to be in the form of a complex. Said complex can be in the form of a sheet, particularly when it is floating on water. A sheet refers to a broad, relatively thin, layer. Since the sheet floats on water, it acts as a covering layer on the water.

Upon removal of said complex from the water on which the complex floats, said complex can become broken into smaller pieces, such that each piece remains a complex with composition essentially the same as that of the unbroken complex. The smaller pieces may be in the form of small sheets, platelets, globules, particles, prisms, cylinders, other shapes, or combinations thereof.

The use of fibers further enables the product of said coagulation (i.e., said complex) to have the ability to provide liquid oil upon being deformed. For example, the deformation involves compression or squeezing. Due to the softness of the coagulation product, the pressure required for the compression is small.

The fibers are preferably discontinuous, since discontinuous fibers are less expensive than continuous fibers of the same composition and discontinuous fibers can be incorporated in a mixture that comprises particles (whereas continuous fibers cannot). The fibers are preferably sufficiently short for them to be conveniently incorporated in said mixture.

The fibers in a complex or a mixture do not need to be all of the same length; they can have a distribution of lengths. The fibers in a complex or mixture do not need to be all of the same aspect ratio; they can have a distribution of aspect ratios.

The fiber length is preferably in the range from 30 μm to 1 cm and most preferably in the range from 100 μm to 2 mm. The aspect ratio is preferably in the range from 1 to 5000 and most preferably in the range from 3 to 1000.

The fibers in a complex or a mixture do not need to be all of the same cross-sectional shape; they can have a variety of shapes. The cross-sectional shape and dimensions do not need to be constant along the length of a fiber. The cross-sectional shapes can be circles, ellipses, oval shapes, convex shapes, concave shapes, squares, rectangles, polygons, trapezoids, parallelograms, irregular shapes, annular shapes, C-shapes (resembling the letter “C”), and combinations thereof.

The fibers are not necessarily straight. They can be straight or bent.

The fibers are in a plurality of directions. They are preferably in a large number of directions. In case of discontinuous fibers, the fibers are not aligned and are thus in a plurality of directions. In case of continuous fibers, the fibers can be oriented or not oriented and are in multiple directions. For example, the continuous fibers are oriented and woven to form a fabric that contains fibers in a plurality of directions in the plane of the fabric.

Although organobentonite gives higher coagulation efficiency than unmodified bentonite, it is much more expensive than unmodified bentonite.

This invention is also aimed at advancing the technology of oil coagulation in water by the novel combined use of fibers, a low proportion of bentonite and a still lower proportion of calcium hydroxide.

The use of a mixture of fibers and bentonite, with the fibers being the vast majority, is highly effective for the coagulation of oil in water, giving a high coagulation efficiency (e.g., 92%). A minor amount of calcium hydroxide may be optionally added to the mixture to increase the coagulation efficiency further (e.g., to 94%).

The use of organobentonite in place of unmodified bentonite increases the coagulation efficiency further (e.g., to 95%), but it increases the cost. Thus, unmodified bentonite is more cost-effective than organobentonite for oil coagulation.

Sawdust refers to particles (including discontinuous fibers) of wood formed by sawing. It is a preferred type of fiber due to its low cost compared to polymer fibers, carbon fibers, carbon nanofibers, carbon nanotubes, glass fibers, ceramic fibers, silicon carbide whiskers, tubular clays, halloysite nanotubes, etc. Sawdust is also preferred due to its low density compared to carbon fibers, carbon nanofibers, carbon nanotubes, glass fibers, ceramic fibers, silicon carbide whiskers, tubular clays, halloysite nanotubes, etc. In addition, sawdust is preferred because it is a natural material that does not pollute the environment and because it is a waste material, the usage of which is environmentally attractive. Furthermore, the production of sawdust is not energy intensive, in contrast to the substantial energy consumption associated with the fabrication of synthetic fibers, such as carbon fibers, glass fibers, ceramic fibers, polymer fibers and silicon carbide whiskers.

Fibers sink in water if their density is higher than that of water; they float on water if their density is lower than that of water. Sawdust may sink in water or float on water, depending on the type of wood from which the sawdust is obtained. In particular, sawdust obtained from pine wood sinks in water, because its density is slightly higher than that of water. Whether the fibers by themselves sink in water or float on water, the oil coagulation product obtained by using fibers in combination of bentonite in accordance with the teachings of this invention floats on water.

The coagulation product is in the form of a semisolid complex, with the oil-fibers-bentonite multi-component material (in which oil, fibers and bentonite are finely commingled components that are integrated in a microscopic scale) serving as a continuous matrix and with the fibers forming a framework. In case that said complex is in the form of a sheet, said framework is substantially in the plane of said sheet and said framework extends substantially over the area of said sheet. The complex contains, for example, 81 vol. % oil, 15 vol. % sawdust, 3 vol. % bentonite (with basal spacing 14.4 Å) and 1 vol. % calcium hydroxide.

Upon compression at a pressure that is sufficient to deform (squeeze) said complex, a high proportion (e.g., 73%) of the oil in the coagulation product is removed (recovered), thus becoming free liquid oil.

The recovery of liquid oil from said complex can be achieved by simply squeezing the complex at a moderate pressure. Heating is not required.

The fibers function as a framework for the attachment of the coagulating oil and coagulation-causing bentonite, thus facilitating the formation of a floating coagulation product (said complex) and also facilitating the subsequent removal of the coagulation product. Without fibers, the coagulation product, which does not exhibit the composition of said complex, sinks in water and the coagulation efficiency is low (e.g., 37%).

In the presence of bentonite, the fibers enhance the coagulation efficiency significantly, while calcium hydroxide enhances the coagulation efficiency by a much lower degree. Thus means that bentonite is required, whereas calcium hydroxide is optional.

### EXAMPLES

### Example 1

### Ingredients Involved in Oil Coagulation

This example describes the ingredients involved in oil coagulation.

Tap water was used in the experiments. The oil is HE-175 vacuum pump oil (a hydraulic fluid), which is a highly distilled pure hydrocarbon oil (solvent refined neutral paraffinic oil) from Leybold (Export, Pa.). The chemical formula is (CH₂)ₙ, where 20≦n≦40. It is an amber viscous liquid, insoluble in water, with density 0.88 g/cm³, vapor pressure less than 1 Pa at 20° C.; and boiling point above 200° C.

The calcium hydroxide is a white powder from J. T. Baker, Phillipsburg, N.J. (Product 1372-01). It contains 97.0% Ca(OH)₂, 2.3% CaCO₃, 0.9% magnesium and alkali salts (as SO₄), 0.03% Fe and 0.02% Cl⁻. Its density is 2.24 g/cm³ and it is slightly soluble in water (0.185 g/100 cm³ at 0° C.). Its melting point is 580° C. Its particle size is such that 99% passes U.S. 325 mesh (44 μm).

The fibers are in the form of sawdust, which was obtained from pine wood. The density is 1.05 g/cm³, which is slightly higher than the value (1.00 g/cm³) for water Thus, the sawdust by itself sinks in water. The sawdust has a fibrous morphology, with the fiber diameter ca. 10 μm.

The bentonite is sodium bentonite in powder form (M325, provided by Asbury Graphite Mills, Inc., Asbury, N.J.) and containing 2-6% free SiO₂ and has less than 10% moisture. It has a cation exchange capacity (CEC) 92 cmol/kg, density 2 g/cm³ and negligible solubility in water. 98.65% of the powder passes through U.S. 325 mesh (44 μm).

The organobentonite is Cloisite 10A, as provided by Southern Clay Products, Inc., Gonzales, Tex. It consists of montmorillonite intercalated with a salt of dimethyl benzyl hydrogenated tallow with quaternary ammonium cations and chloride anions, and basal spacing d₀₀₁ 19.2 Å. The CEC is 125 cmol/kg. Its particle size distribution is: 10% less than 2 μm, 50% less than 6 μm and 90% less than 13 μm. The density is 1.90 g/cm³. Montmorillonite is hydrophilic, but ion exchange involving the ammonium salt renders the clay more hydrophobic. The organobentonite has a reduced surface energy, which is well-suited for use with oil.

### Example 2

### Coagulant Formulations

This example describes specific coagulant formulations, as prepared using the ingredients described in Example 1.

Four coagulant formulations were used, namely (i) organobentonite, calcium hydroxide and sawdust, (ii) unmodified bentonite, calcium hydroxide and sawdust, (iii) unmodified bentonite and sawdust, and (iv) unmodified bentonite and calcium hydroxide. The proportions of the ingredients are given below. Unmodified bentonite is also referred to as bentonite.

In formulations (i) and (ii), the mass ratios of bentonite (either unmodified bentonite or organobentonite), sawdust and calcium hydroxide are 0.375:1.000:0.125, and the volume ratios are 0.198:1.00:0.059.

In formulation (iii), the bentonite proportion increased, so that the mass ratio bentonite:sawdust was 0.500:1.000, and the volume ratio was 0.26:1.00.

In formulation (iv), the mass ratio bentonite:calcium hydroxide was 0.375:0.125, and the volume ratio was 0.19:0.056.

The four formulations allow investigation of (i) the effect of calcium hydroxide for oil coagulation in the presence of unmodified bentonite and sawdust, (ii) the effect of sawdust on oil coagulation in the presence of unmodified bentonite and calcium hydroxide, and (iii) the effect of sawdust in conjunction with calcium hydroxide on oil coagulation in the presence of unmodified bentonite.

### Example 3

### Coagulation Evaluation Methods

This examples describes the methods of coagulation evaluation. The coagulant formulations, as described in Example 2, are prepared using the ingredients described in Example 1.

Coagulation evaluation is conducted using a small-scale experiment and a medium-scale experiment. The medium-scale testing involved an area of 2,700 cm² for the surface of the liquid (water with oil), whereas the small-scale testing involved a corresponding area of 54 cm². The small-scale method was used for initial evaluation of all the formulations, with three tests performed for each formulation. Subsequently, the medium-scale method was used for further evaluation of formulation (ii) (Example 2), which was found to be the most effective by small-scale testing in terms of performance and cost. The medium-scale method involved only one test.

### Example 4

### Small-Scale Coagulation Evaluation Method

This example provides details of the small-scale coagulation evaluation method. The coagulant formulations, as described in Example 2, are prepared using the ingredients described in Example 1.

In 250 cm³ of tap water (pH=7) placed in a 500 ml glass beaker with internal diameter 83 mm, 5 g of oil (5.7 cm³, i.e., 2.2 vol. %) were added. The liquid mixture was stirred with a magnetic stirrer at 70 rpm for 30 min and then it was allowed to stand for 1 min, whereby the oil droplets floated on the water surface. Then the various coagulant formulations (bentonite, organobentonite, calcium hydroxide and/or sawdust, as applicable), formed by manual mixing, was sprinkled gradually on the surface of the liquid in the beaker by with a plastic spoon. Then over a period of 75 min, the oil was allowed to coagulate and form oil-solid coagulation products.

In the formulations involving sawdust (Example 2), the coagulation product floated on water, whereas in the formulation without sawdust, the coagulation product sank. The floated coagulation product on water was collected with a spoon. Coagulation products that sank in water were collected from the bottom of the beaker with a spoon after decantation of the supernatant water. All the coagulation products that had been removed manually from the beaker were filtered for 45 min using previously weighed filter paper (Whatman Grade No. 2). After filtration, the coagulation product and the filter paper were dried in a vacuum drying oven at 110° C. for 30 min. Subsequently they were allowed to cool at room temperature and equilibrate with air for 24 h and finally they were weighed.

The liquid was poured out of the beakers and the oil which was retained in the inner surface of the beaker and the surface of the spoon was cleaned with filter paper. After vacuum drying at 110° C., the soaked filter paper was weighed and the weight of the retained oil was recorded and was subtracted from the original oil weight (5.000 g). The amount of oil available for coagulation was obtained by difference. The coagulation efficiency E refers to the fraction of oil that is removed by coagulation and was calculated from the equation

E=1−{[(5.000−R+B+C+S+F)−G]/(5.000−R)}, (1)

where R is the weight of the retained oil, B is the bentonite (or organobentonite) weight, C is the Ca(OH)₂ weight, S is the sawdust weight, F is the filter paper weight, and G is the weight of the coagulated material together with the filter paper after drying.

### Example 5

### Medium-Scale Coagulation Evaluation Method

This example provides details of the medium-scale coagulation evaluation method. The coagulant formulations, as described in Example 2, are prepared using the ingredients described in Example 1.

The medium-scale experiments involved a relatively large area over which oil coagulation occurred. The method used is basically the same as in the small-scale experiments except for the container area and the amounts of materials.

A rectangular black plastic container 600×450×150 mm was used. The materials used were water (10 kg), oil (150 g), bentonite (11.25 g), calcium hydroxide (3.75 g) and sawdust (30 g). Relative to the mass of the oil, the proportions (by mass) of bentonite, calcium hydroxide and sawdust were the same as in the small-scale experiments (i.e., bentonite/oil ratio=0.075, calcium hydroxide/oil ratio=0.025, and sawdust/oil ratio=0.2). The oil/water mass ratio was slightly lower in the medium-scale experiments compared to the small-scale experiments (0.015 and 0.02 respectively). The concentration of oil in the liquid was 1.7 vol. % in the medium-scale experiments and 2.2 vol. % in the small-scale experiments.

The filter paper (3.086 g) was a stack of three coffee filters (CVS, basket style) with basal diameter 82.5 mm made from paper. In contrast to the small-scale experiments, the mixture of oil and water was stirred manually with a plastic spoon for 30 min and the coagulation time was 24 h instead of 75 min.

### Example 6

### Method of Microscopic Examination of the Coagulation Product

This example describes the method of microscopic examination of the coagulation product. The coagulant formulations, as described in Example 2, are prepared using the ingredients described in Example 1.

The coagulation product corresponding to each of the four formulations (Example 2) was examined by scanning electron microscopy (SEM) coupled with elemental analysis by X-ray spectroscopy (EDS), using a Hitachi SU70 system. The purpose was to study the microstructure of each type of coagulation product.

The coagulation product removed from the water in which oil coagulation occurred was examined after drying in air at room temperature for the purpose of removing by evaporation the water retained after filtration (Example 4). In addition, the coagulation product was examined after both said evaporation and subsequent exposure to vacuum drying at room temperature for the purpose of drying the oil and thus exposing the fibrous framework. After the drying of the oil, the previously sticky and agglomerated sheet became disaggregated, but the framework became observable under the microscope.

### Example 7

### Method of X-Ray Diffraction Examination of the Coagulation Product

This example describes the method of x-ray diffraction examination of the coagulation product. The coagulant formulations, as described in Example 2, are prepared using the ingredients described in Example 1.

Powder X-ray diffraction (XRD) of the original bentonite and the coagulation product (formulation (ii)) was conducted with CuKα radiation (40 kV, 30 mA) using a Siemens Kristalloflex diffractometer equipped with a diffracted-beam graphite monochromator.

### Example 8

### Method of Evaluation of the Extent of Oil Removal from the Coagulation Product by Compression

This example describes the method of evaluation of the extent of oil removal from the coagulation product by compression. The coagulant formulations, as described in Example 2, are prepared using the ingredients described in Example 1.

The extent of oil removal from the coagulation product by compression was evaluated. The coagulation product was placed between two pre-weighed paper towels. The coagulation product and the filter papers (“sandwich”) was weighed and the mass of the coagulation product used in the evaluation was obtained. Then the sandwich was compressed for 15 min perpendicular to its main area with a force of 400 lb, which corresponded to a pressure of 3.3±2.1 MPa. The variation in pressure, as indicated by the ± range, resulted from the variation in the area of the tested material. During compression part of the oil was expelled from the coagulation product and was soaked by the paper towel.

Subsequently, the coagulation product was removed from the paper towels and the latter were then weighed. The difference between the mass of the paper towels before and after oil soaking yielded the mass of the oil that had been removed from the coagulation product during this compression process. The mass of the removed oil divided by the mass of the coagulation product prior to compression yielded the mass fraction of oil removed from the coagulation product. This mass fraction divided by the mass fraction of oil in the coagulation product prior to compression (as determined in the coagulation evaluation described in Example 4) gave the fraction of oil in the coagulation product that was removed by compression. The test was conducted in triplicate corresponding to formulation (ii) (Example 2).

### Example 9

### Small-Scale Evaluation Results

This example describes the small-scale evaluation results, as obtained using the evaluation method described in Example 4 using the formulations described in Example 2. The ingredients are as described in Example 1.

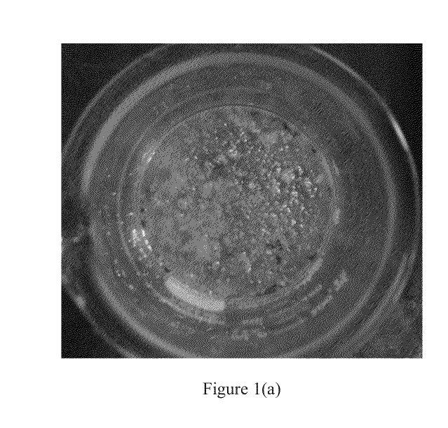

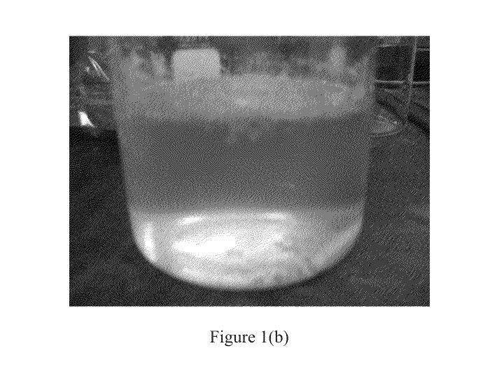

For all three formulations involving sawdust (Example 2), the coagulation product floated on the water, with the coagulation product occurring as a single sheet of diameter limited by the diameter of the beaker and thickness ca. 5 mm (FIG. 1). The sheet contained sawdust at much higher concentration than the bentonite content. Although sawdust sank in water, the coagulation product with bentonite floated on water because the sawdust functioned as a fibrous framework for the attachment of the coagulated oil and bentonite and the oil had lower density than water. Thus, the sawdust facilitated the formation and subsequent removal of a coagulation product in the form of a sheet.

In formulation (iv) (Example 2), which did not contain sawdust, the coagulation product sank in the water and formed particles of size of the order of 1 mm. Although the particles were interconnected to a limited degree, they did not form a complete sheet.

Although the proportion of bentonite was much lower than that of the sawdust, bentonite was the main coagulant. In a simple experiment in which bentonite was mixed with either oil or water to form a clay ball, we found that bentonite adsorbed both oil and water. The affinity of bentonite for oil assisted bentonite to serve as a coagulant. In addition, bentonite acted as an emulsifier, with the opposite charges on the oil droplets and montmorillonite causing attraction.

The oil-sawdust-bentonite coagulation product (said complex) is useful not only for the separation of oil from water, but is also valuable as a handleable fuel. This is because both oil and sawdust in the coagulation product are fuels and they constitute the majority of the coagulation product. For example, in case of formulation (ii) (Example 2), the coagulation product contained 75.6 wt. % oil, 16.3 wt. % sawdust, 6.1 wt. % bentonite and 2.0 wt. % calcium hydroxide, i.e., 81.5 vol. % oil, 14.7 vol. % sawdust, 2.9 vol. % bentonite and 0.9 vol. % calcium hydroxide. The large size of the coagulation product and the mechanical integrity provided by the sawdust, which acts as a reinforcement, make it convenient to use the coagulation product as a fuel. In addition, the coagulation product may be deformed or squeezed to remove the oil from the coagulation product, thus providing liquid oil fuel.

Table 1 shows the coagulation results for formulations (i), (ii), (iii) and (iv) (Example 2). Formulation (i) gave the highest coagulation efficiency. Comparison of the coagulation efficiency for formulations (i) and (ii) showed that organobentonite was more effective than unmodified bentonite. Formulation (ii) was more effective than formulation (iii), indicating that Ca(OH)₂ enhanced the coagulation efficiency in the presence of bentonite and sawdust. Formulation (iii) was much more effective than formulation (iv), indicating that sawdust was much more important than Ca(OH)₂ in enhancing the coagulation efficiency in the presence of bentonite.

TABLE 1
Coagulation results obtained by small-scale testing for the four coagulant
formulations. H is the weight of the oil used; R is the weight of the
retained oil; B is the bentonite (or organobentonite) weight; C is the
Ca(OH)₂ weight; S is the sawdust weight; F is the filter paper
weight; G is the weight of the coagulated material together with the
filter paper after drying; E is the coagulation efficiency.

| | Formulation | | | |
|---|---|---|---|---|
| | (i) | (ii) | (iii) | (iv) |
| H (g) | 5.000 | 5.000 | 5.000 | 5.000 |
| R (g) | 0.190 | 0.219 | 0.232 | 0.312 |
| B (g) | 0.375 | 0.375 | 0.500 | 0.375 |
| C (g) | 0.125 | 0.125 | 0 | 0.125 |
| S (g) | 1.000 | 1.000 | 1.000 | 0 |
| F (g) | 1.215 | 1.219 | 1.221 | 1.177 |
| H + B + C + S + F (g) | 7.715 | 7.719 | 7.721 | 6.677 |
| G (g) | 7.305 | 7.238 | 7.120 | 3.381 |
| E | 0.9543 | 0.9452 | 0.9226 | 0.3635 |
| E (based on 3 tests per | 0.952 ± | 0.942 ± | 0.923 ± | 0.372 ± 0.024 |
| formulation) | 0.010 | 0.014 | 0.007 | |

Although formulation (i) (Example 2) is the most effective among the four formulations studied, it is expensive, due to the presence of organobentonite. Thus, formulation (ii) is more attractive when both cost and performance are taken into consideration.

The four formulations (Example 2) involve either organobentonite or unmodified bentonite as the base coagulant. Due to the strong thixotropic behavior of bentonite or organobentonite, Ca(OH)₂ (a coagulation aid) and/or sawdust (an agent that provides framework and buoyancy and serves as an oil adsorbent) is used to reduce the thixotropy. Calcium hydroxide strengthens the coagulating function of bentonite.

### Example 10

### Medium-Scale Evaluation Results

This example describes the results of medium-scale evaluation using the method described in Example 5 and the formulation (ii) described in Example 2. The ingredients are as described in Example 1.

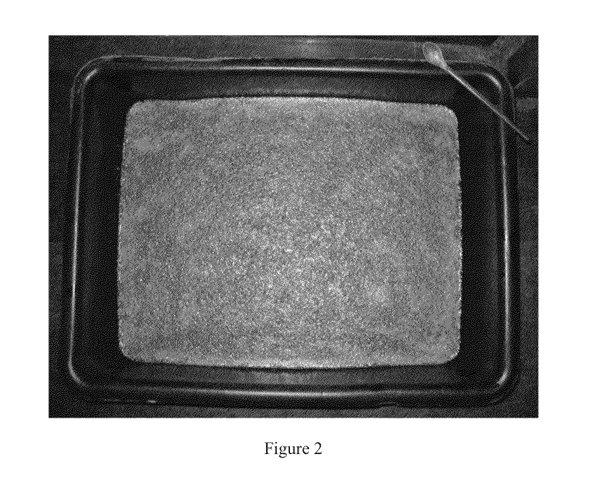

The coagulation product formed a sheet with size restricted by the container walls (FIG. 2). Thus, the upper limit of the coagulation product size probably exceeded 600 mm. In fact, probably there was no upper limit, provided that the coagulant mixture was uniformly applied to the surface of the liquid containing the oil, because the sawdust provides a continuous framework to the resulting coagulation product sheet. The coagulation product after drying weighed 186.908 g. The retained oil weighed 2.901 g. Hence, according to Eq. (1), the coagulation efficiency was 0.924, i.e., slightly lower than the corresponding value of 0.942 obtained in small-scale experiments. The fraction of oil that was retained was 1.9%, compared to the corresponding value of 4.4% for small-scale testing. This difference is attributed to the greater difficulty in recovering all of the retained oil in the medium-scale experiments. The accuracy of the coagulation efficiency was thus lower for the medium-scale experiments than the small-scale experiments (Example 9).

### Example 11

### Microscopic Examination Results for the Coagulation Products Containing Oil Prior to Drying the Oil

This example describes the results of microscopic examination of coagulation products containing oil prior to drying the oil in vacuum. The method of examination is as described in Example 6 and the formulations are as described in Example 2. The ingredients are as described in Example 1.

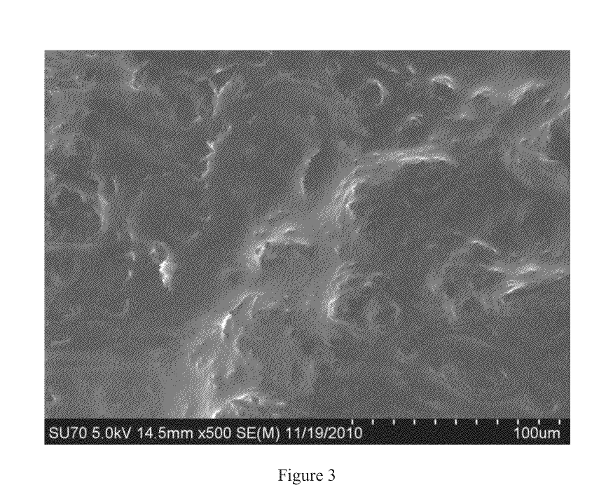

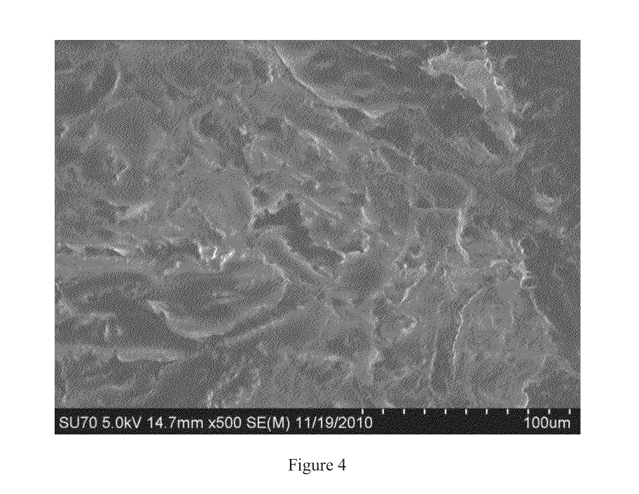

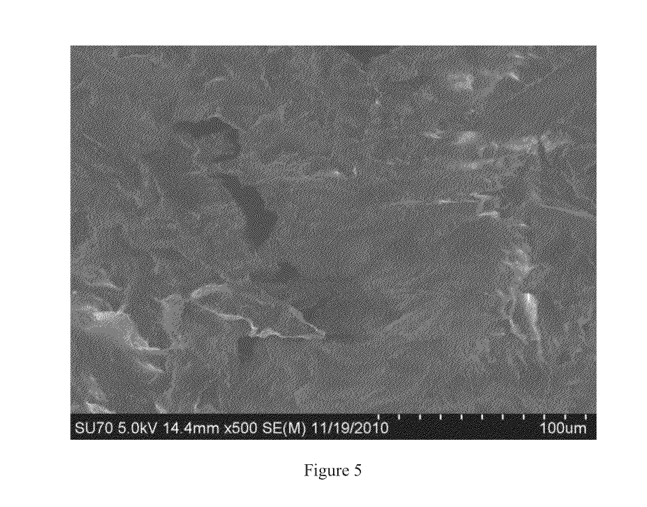

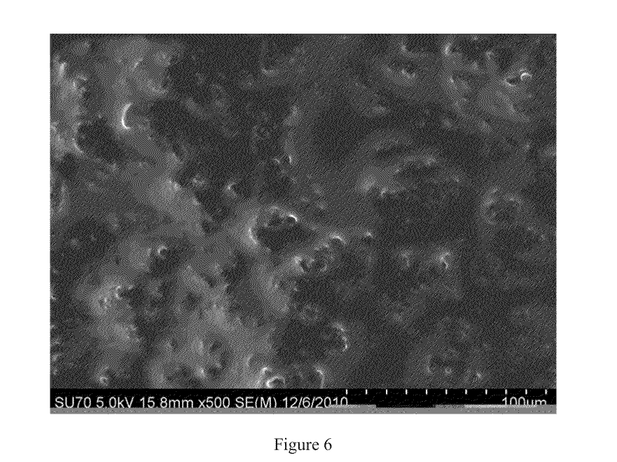

FIGS. 3-6 show SEM photographs of the coagulation product containing oil prior to air drying and obtained by using formulations (i), (ii), (iii) and (iv) (Example 2) respectively. In spite of the presence of sawdust, fibrous textures are not present in FIGS. 3-5, suggesting that the sawdust and the bentonite formed a rather uniform sheet of coagulation product. FIGS. 3 and 4 show particles that were essentially encased in a continuous oil-bentonite-sawdust matrix. In contrast, in FIG. 5, individual particles were not observed, partly due to the absence of calcium hydroxide, but the oil-bentonite-sawdust matrix was continuous. In the absence of sawdust, the microstructure was less smooth, with particles (about 5-10 μm in size) that protruded partly from an oil-bentonite matrix (FIG. 6). The particles in FIGS. 3 and 4 appeared smaller, because they were essentially embedded in the matrix.

### Example 12

### Microscopic Examination Results for the Coagulation Products After Drying the Oil

This example describes the results of microscopic examination of coagulation products after drying the oil in vacuum using the method described in Example 6 and the formulations (ii) and (iv) described in Example 2. Formulation (ii) contained sawdust, whereas formulation (iv) did not. The ingredients are as described in Example 1.

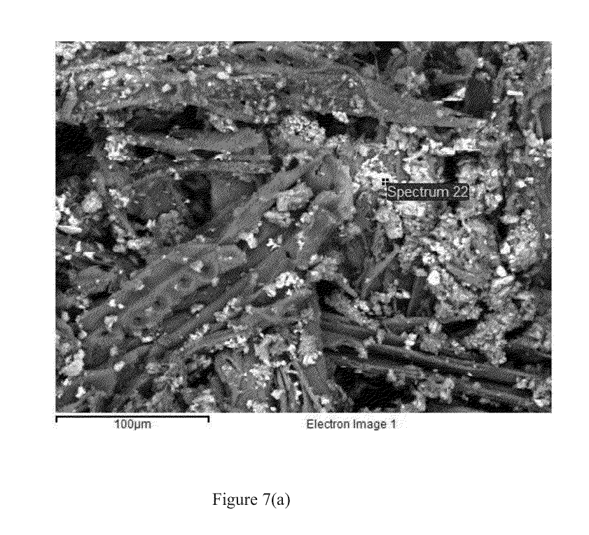

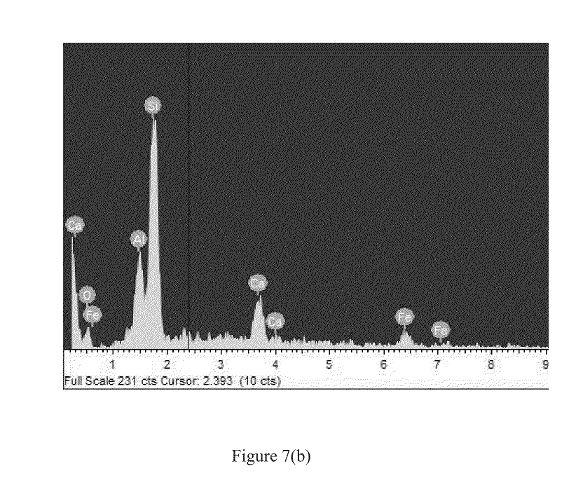

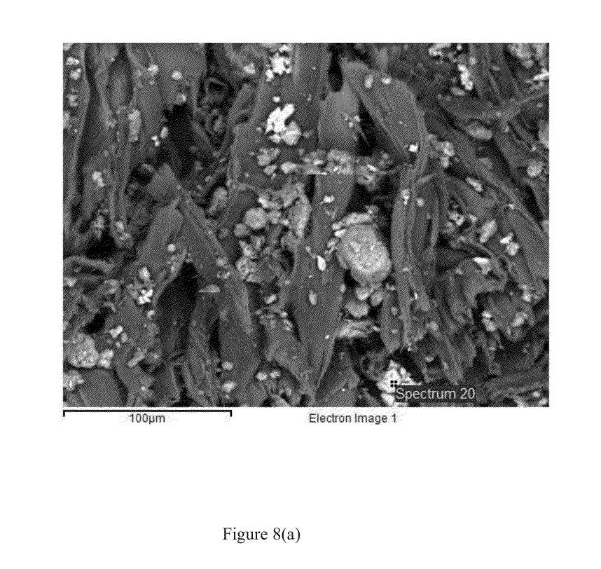

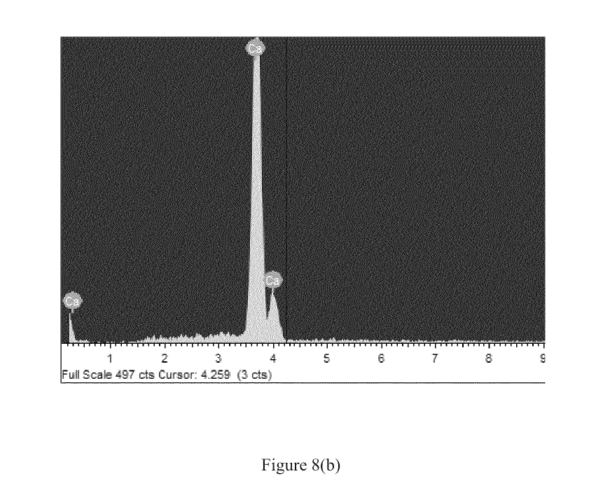

Although a continuous span of matter was observed for the oil-containing coagulation product corresponding to formulation (ii) and the sawdust essentially could not be discerned (FIG. 4, last paragraph), the sawdust skeleton and the particles clung to it were observed after drying the oil (FIGS. 7 and 8). The relatively large particles, which resembled to patches of particle agglomerates, are attributed mainly to bentonite, as shown by the EDS spectra (FIG. 7). The relatively small particles were rich in calcium, so they are attributed to calcium hydroxide (FIG. 8).

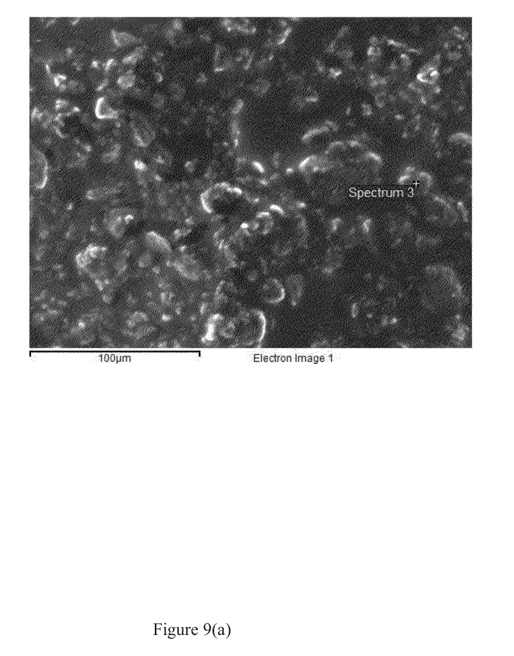

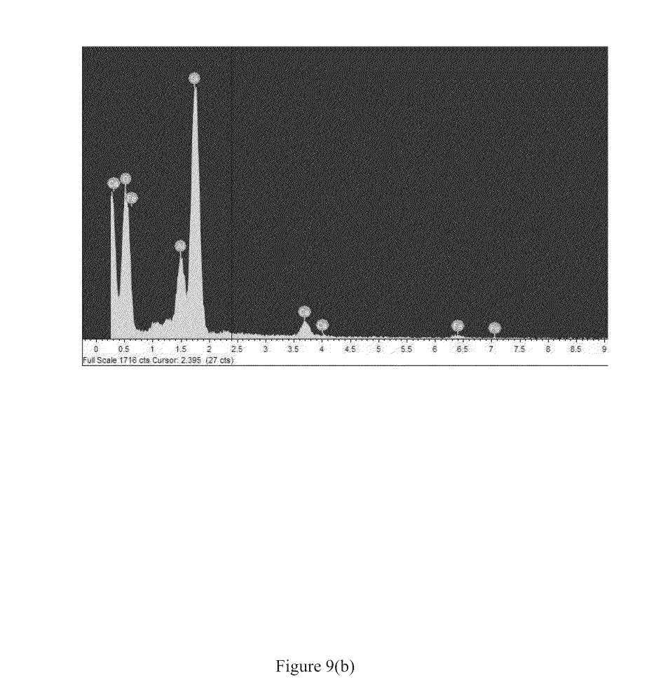

For formulation (iv), the sawdust skeleton was absent, as expected. However, particles were observed (FIG. 9(a)). The particles protruded more clearly compared to the materials prior to drying the oil (FIG. 6). They belong to bentonite and calcium hydroxide, as shown by the EDS spectra (FIG. 9(b)).

### Example 13

### Results of X-Ray Diffraction

This example describes the results of x-ray diffraction conducted using the method described in Example 7 and the formulations described in Example 2. The ingredients are as described in Example 1 .

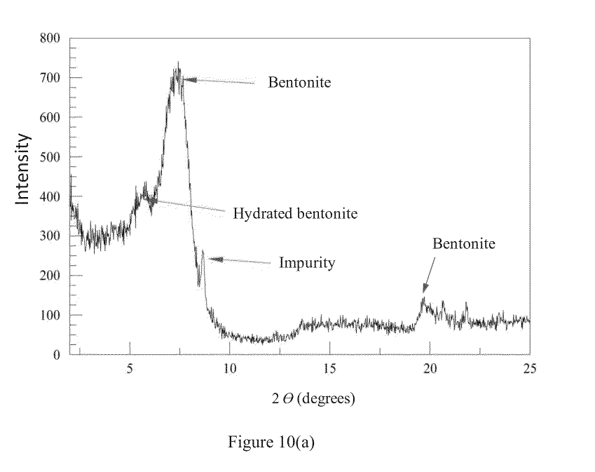

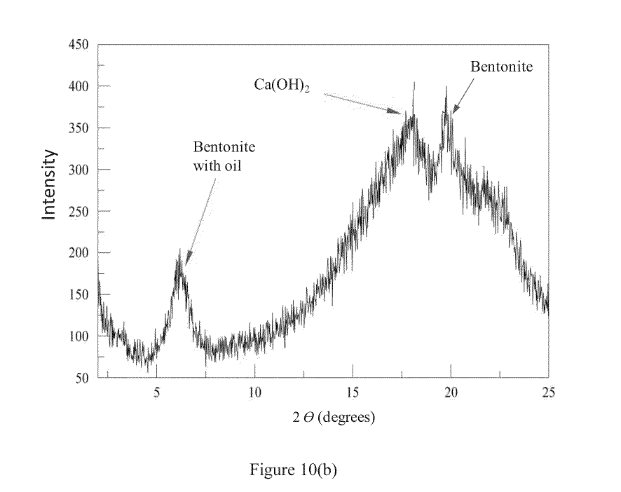

FIG. 10 shows X-ray diffraction patterns of bentonite in the as-received state and that in the state corresponding to the coagulation product. The montmorillonite basal spacing (d₀₀₁) increased from 12.0 Å in the as-received state to 14.4 Å in the coagulation product (with sawdust and calcium hydroxide, formulation (ii)). These values suggest that oil is intercalated between the clay layers in bentonite in the coagulation product. However, it is also possible that the increase in d₀₀₁ is due to an increase in the moisture content. Furthermore, it is possible that the increase in d₀₀₁ is due to the Ca from Ca(OH)₂ and the tap water exchanging Na from the montmorillonite. At any rate, the consequence is a volume increase of 20% for the bentonite. As mentioned in Example 9 in relation to formulation (ii), the coagulation product contained 81.5 vol. % oil, 14.7 vol. % sawdust, 2.9 vol. % bentonite and 0.9 vol. % calcium hydroxide. If intercalation of oil had occurred in the coagulation product, the observed 20% increase in the bentonite volume would be due to oil and the coagulation product composition would be 80.9 vol. % free oil, 14.7 vol. % sawdust, 3.5 vol. % oil-intercalated bentonite and 0.9 vol. % calcium hydroxide. The vast majority of the oil in the coagulation product was not intercalated in the montmorillonite interlayer space.

FIG. 10(a) also shows the presence of a small proportion of hydrated bentonite in the as-received bentonite. The impurity peak is probably due to mica. FIG. 10(b) shows the presence of an intense and broad hump, which is probably due to turbostratically disordered Ca-montmorillonite. Superposed on this hump are a peak attributed to Ca(OH)₂ and a peak attributed to montmorillonite.

### Example 14

### Results of Evaluation of the Extent of Oil Removal from the Coagulation Product by Compression

This example describes the results of evaluation of the extent of oil removal from the coagulation product by compression, using the method described in Example 8 and formulation (ii) described in Example 2. The ingredients are as described in Example 1.

Based on the masses of the ingredients, the mass fraction of oil in the coagulation product was 0.756. The results of three tests involving formulation (ii) (Example 2) show that the removed oil amounted to 55±4% of the coagulation product mass prior to compression. This corresponded to 73±5% of the oil in the coagulation product prior to compression. The scatter of the data was mainly due to the variation in the specimen area.

### Example 15

### Summary of the Results in Examples 9-14

This example summarizes the results described in Example 9-14.

The use of a mixture of bentonite and sawdust, with sawdust being the vast majority, is highly effective and cost-efficient for the coagulation of oil in water, with coagulation efficiency greater than 92%. A minor amount of calcium hydroxide may be optionally added to the mixture to increase the coagulation efficiency in excess of 94%. Sawdust (79.6 vol. %), unmodified bentonite (15.8 vol. %) and calcium hydroxide (4.7 vol. %) used as a mixture gave coagulation efficiency 94% for an oil concentration of 2.2 vol. % in water. This formulation is recommended for use in the cleaning up of oil spills.

Sawdust by itself sank in water. However, the coagulation product floated on water when sawdust was used with the bentonite. A large sheet of coagulation product formed, with the oil-bentonite-sawdust serving as a continuous matrix. The upper limit of the coagulation product size exceeded 600 mm; this large size was facilitated by the presence of sawdust. The coagulatin product contained 81 vol. % oil, 15 vol. % sawdust, 3 vol. % unmodified bentonite (with interlayer distance 14.4 Å) and 1 vol. % calcium hydroxide. Upon compression, 73% of the oil in the coagulation product was removed. The sawdust-free coagulation products had small size and were not smooth in morphology; they sank in water and corresponded to a low coagulation efficiency (37%). The sawdust functioned as a fibrous framework for the absorption and adsorption of oil droplets and bentonite particles, thus facilitating the formation and the subsequent removal of coagulation products of large sizes.

In the presence of unmodified bentonite, sawdust enhanced the coagulation efficiency significantly, while calcium hydroxide enhanced the coagulation efficiency to a considerably lower degree. The use of organobentonite (with dimethyl benzyl hydrogenated tallow as modifier) instead of unmodified bentonite in the formulation with calcium hydroxide and sawdust slightly increased the coagulation efficiency to 95%. However, organobentonite is much more expensive than unmodified bentonite.

Although preferred embodiments have been depicted and described in detail herein, it will be apparent to those skilled in the relevant art that various additions, substitutions, modifications and the like can be made without departing from the spirit of the invention and these are therefore considered to be within the scope of the invention as defined in the claims which follow.

What is claimed:

1. A semisolid complex exhibiting
(i) the ability to float on water,
(ii) the ability to provide liquid oil upon being deformed, and
(iii) the ability to function as a fuel,
said complex comprising a high proportion of liquid oil,
the density of said oil being lower than the density of water,
said complex also comprising fibers,
said fibers being oriented in a plurality of directions,
said fibers forming a framework,
said framework being incorporated in said complex,
said framework being substantially in the plane of said complex in case that said complex is in the form of a sheet, and
said framework extending substantially over the area of said complex in case that said complex is in the form of a sheet,
said complex further comprising a low proportion of bentonite,
said bentonite being associated with said oil,
said associating substantially involving coagulation,
said oil and said bentonite being substantially held by said framework.

2. The complex of claim 1, wherein said oil is chosen from the group consisting of hydrocarbon oils, polyols, organic liquids, mineral oils, hydraulic fluids, crude oils, bunker oils, lubricant oils, and combinations thereof.

3. The complex of claim 1, wherein said bentonite is chosen from the group consisting of sodium bentonite, calcium bentonite, magnesium bentonite, potassium bentonite, aluminum bentonite, organobentonite, montmorillonite, smectite clay, phyllosilicates, aluminum silicate clay, and combinations thereof.

4. The complex of claim 1, wherein said fibers are chosen from the group consisting of sawdust, stalk, paper, wood, cellulose, plant fibers, hairs, feathers, natural fibers, synthetic fibers, polymer fibers, carbon fibers, carbon nanofibers, carbon nanotubes, glass fibers, ceramic fibers, silicon carbide whiskers, tubular clays, halloysite nanotubes, and combinations thereof.

5. The complex of claim 1, wherein said oil is in an amount ranging from 65 vol. % to 95 vol. % of said complex.

6. The complex of claim 1, wherein said fibers are in an amount ranging from 5 vol. % to 25 vol. % of said complex.

7. The complex of claim 1, wherein said bentonite is in an amount ranging from 1 vol. % to 5 vol. % of said complex.

8. The complex of claim 1, wherein said complex further comprises calcium hydroxide.

9. A composition for causing the coagulation of a substantial portion of the oil present in a liquid upon addition of said composition to said liquid,
wherein said liquid comprises a high proportion of water, and
said liquid also comprises said oil,
the density of said oil being lower than the density of said water,
said composition comprising a mixture,
said mixture comprising a high proportion of discontinuous fibers,
said fibers being oriented in a plurality of directions,
said mixture also comprising bentonite particles,
said bentonite particles being sufficiently high in proportion for associating with a substantial portion of said oil,
said associating substantially involving coagulation, and
said fibers being sufficiently low in density and sufficiently high in proportion for causing the product of said coagulation to exhibit the ability to float on water.

10. The composition of claim 9, wherein said bentonite is chosen from the group consisting of sodium bentonite, calcium bentonite, magnesium bentonite, potassium bentonite, aluminum bentonite, organobentonite, montmorillonite, smectite clay, phyllosilicates, aluminum silicate clay, and combinations thereof.

11. The composition of claim 9, wherein said fibers are chosen from the group consisting of sawdust, stalk, paper, wood, cellulose, plant fibers, hairs, feathers, natural fibers, synthetic fibers, polymer fibers, carbon fibers, carbon nanofibers, carbon nanotubes, glass fibers, ceramic fibers, silicon carbide whiskers, tubular clays, halloysite nanotubes, and combinations thereof.

12. The composition of claim 9, wherein said fibers are in an amount ranging from 70 vol. % to 95 vol. % of said mixture.

13. The composition of claim 9, wherein said bentonite is in an amount ranging from 5 vol. % to 30 vol. % of said mixture.

14. The composition of claim 9, wherein said mixture also comprises calcium hydroxide.

15. A method of coagulation of a substantial portion of the oil present in a liquid,
wherein said liquid comprises a high proportion of water, and
said liquid also comprises said oil,
the density of said oil being lower than the density of said water,
said method comprising the addition of a mixture to said liquid,
said mixture comprising a high proportion of discontinuous fibers,
said fibers being oriented in a plurality of directions,
said mixture also comprising bentonite particles,
said bentonite being sufficiently high in proportion for associating with a substantial portion of said oil,
said associating substantially involving coagulation, and
said fibers being sufficiently low in density and sufficiently high in proportion for causing the product of said coagulation to exhibit the ability to float on water,

16. The method of claim 15, wherein said bentonite is chosen from the group consisting of sodium bentonite, calcium bentonite, magnesium bentonite, potassium bentonite, aluminum bentonite, organobentonite, montmorillonite, smectite clay, phyllosilicates, aluminum silicate clay, and combinations thereof.

17. The method of claim 15, wherein said fibers are chosen from the group consisting of sawdust, stalk, paper, wood, cellulose, plant fibers, hairs, feathers, natural fibers, synthetic fibers, polymer fibers, carbon fibers, carbon nanofibers, carbon nanotubes, glass fibers, ceramic fibers, silicon carbide whiskers, tubular clays, halloysite nanotubes, and combinations thereof.

18. The method of claim 15, wherein said fibers are in an amount ranging from 70 vol. % to 95 vol. % of said mixture.

19. The method of claim 15, wherein said bentonite is in an amount ranging from 5 vol. % to 30 vol. % of said mixture.

20. The method of claim 15, wherein said mixture also comprises calcium hydroxide.
